(19) United States
(12) Patent Application Publication
(10) Pub. No.: US 2002/0064396 A1
(43) Pub. Date: May 30, 2002

(54) Dicorotron shield for an electrophotographic printer

(76) Inventors: Ted O. Becker, Walworth, NY (US); Kenneth W. Luff, Walworth, NY (US); Clifford Meima, Fairport, NY (US); Brian M. Freyland, Bristol, NY (US); Harold M. Strand, Victor, NY (US)

Correspondence Address: Oliff & Berridge PLC, P.O. Box 19928, Alexandria, VA, 22320, US

(21) Appl. No.: 09/721,950

(22) Filed: Nov. 27, 2000

(51) Int. Cl. G03G 15/02

(52) U.S. Cl. 399/170; 399/172; 250/324

(57) ABSTRACT

An improved dircorotron shield for use in an electrophotographic photorecptor printer. The improved dicorotron shield uses titanium or a titanium alloy to form the dicorotron shield, thereby eliminating the need for a base layer or coating to neutralize the production of deteriorative acids that impair or weaken the surface of the photoreceptor. The use of titanium or a titanium alloy limits the production of unstable ozone O₃ otherwise occurring due to the high energy agitation of atmospheric oxygen O₂ caused by the charging of the corona device the dicorotron shield surrounds. By reducing the production of ozone O₃, the formation of acids is reduced as well. As a result of the reduced acids formed, the titanium or titanium alloy dicorotron shield requires less cleaning or maintenance or replacement.

### BACKGROUND OF THE INVENTION

1. Field of Invention

This invention relates to methods and apparatus for electrophotographic printing using an improved dicorotron shield.

2. Description of Related Art

In electrophotographic printing, also known as electrophotography or xerography, a photoreceptor containing a photoconductive insulating layer on a conductive layer is imaged by first uniformly electrostatically charging its surface. The photoreceptor is then exposed to a pattern of activating electromagnetic radiation, such as light or a scanning laser beam. The radiation selectively dissipates the charge in the illuminated areas of the photoconductive insulating layer while leaving behind an electrostatic latent image in the non-illuminated areas. This electrostatic latent image may then be developed to form a visible image by depositing finely divided toner particles on the surface of the photoconductive insulating layer. The resulting visible image may then be transferred from the photoconductor to a support, such as transparency or paper. This imaging process may be repeated many items.

In order to form the uniform electrostatic charge on the surface of the photoreceptor, practice in the art has been to utilize a corotron or dicorotron device. Typically, such devices include one or more corotrons, or charging wires, located within a housing assembly.

Previous printers used dicorotron shields made of aluminum coated with dispersed aqueous graphite to generate a high voltage, for example up to 7000 volts, for charging a photoreceptor. The aluminum material comprising a first layer of the dicorotron shield and the dispersed aqueous graphite coating comprising a second layer of the dicorotron shield combine to form a shield for containing the high voltage generated by the dicorotron and for directing that charge to the photoreceptor. However, several problems have been noted with this design. For example, the aluminum aspect of the combination shield is generally not a sufficient base to neutralize the production of acids that occur later in the electrophotographic printing process. As a result of the high voltage agitation state produced by the dicorotrons, ozone (O₃) is generated within the dicorotron shield of known printers earlier in the printing cycle. Acids, such as nitrous acid and/or nitric acid, thereafter tend to form via a series of chemical reactions initiated by the unstable ozone (O₃). The acids produced deteriorate and weaken the surface of the dicorotron shield, which can eventually result in uneven charging of the photoreceptor from which the desired image is eventually reproduced onto a receiving sheet. The acids produced also damage the photoreceptor by reducing its ability to accept a uniform charge. Once damaged, the photoreceptor must be replaced, posing significant operating costs.

More specifically, in known electrophotographic printers, when the ozone (O₃) produced by the high voltage induced agitation state of the dicorotron is mixed with nitrogen (N₂), nitrous oxide (N₂O) is produced. The nitrogen (N₂) is readily available as it comprises approximately 78% of the earth's atmosphere. Then, the nitrous oxide (N₂O) is available to react with water (H₂O), also generally present in the atmosphere, to form nitric acid (HNO₃). Most environments where printers exist include the presence of water (H₂O) in sufficient quantity to be a reactant in combination with the nitrogen present in the vicinity of the dispersed aqueous graphite layer. Moreover, the quantity of such water (H₂O) is particularly available as a reactant in periods of high humidity as, for example, during seasonal weather changes. Thus, the formation of deteriorative acids, as for example, nitric acid (HNO₃) is conveniently achieved to the detriment of the image and the printer.

In an effort to reduce the deterioration effects, the dispersed aqueous graphite layer is coated on the aluminum layer of the dicorotron shield to provide an acid-neutralizing effect. The dispersed aqueous graphite coating is basic, i.e., an alkaline material, however. Because of its basic qualities, a dispersed aqueous graphite coating undergoes an acid-base chemical reaction in the presence of an acid as, for example nitric acid (HNO₃). The acid-base chemical reaction between the dispersed aqueous graphite coating and the nitric acid (HNO₃) yields water (H₂O) and a salt. The salt yielded coats the dispersed aqueous graphite layer and inhibits the dispersed aqueous graphite's acid-neutralizing effect. Because of the ozone (O₃) produced in the initial high voltage state of the dicorotron, the nitric acid (HNO₃) production is inevitable. Over time, therefore, the dispersed aqueous graphite coated dicorotron shield's acid-neutralizing effect decreases continuously as the coating of salt overlying the dispersed aqueous graphite coating eventually covers all of the dispersed aqueous graphite coating layer. The salt coating being the result of the acid-base reaction described and rendering the aluminum/dispersed aqueous graphite combination shield ineffective. Furthermore, as the salt deposits build up, it is not a simple operation to remove the salt deposits and thereby restore the acid-neutralizing capability to the graphite layer. Instead, the salt build-up eventually requires that the dicorotron shield be completely replaced. This in turn results in increased cost in maintenance of the printing systems. Typically, such replacement of the dicorotron shield is conducted about every 1 million prints, which may be rather frequent in high-volume systems.

The unique environment in which a dicorotron shield exists contributes to the series of reactions that produce the deteriorative acid that renders the dispersed aqueous graphite coated aluminum dicorotron shield ineffective. For example, the elements of oxygen (O₂) and nitrogen (N₂) comprise twenty-one per cent (21%) and seventy-eight per cent (78%) of the earth's atmosphere. Thus, these elements are present for reactive combination most places where a printer exists.

It is also known that the operation of corona charging devices in an electrophotographic copy machine creates various noxious gases including ozone (O₃). The problem of ozone (O₃) production increases at higher levels of charging. The detrimental effects of ozone (O₃) on machine components and people is well-known. For example, ozone (O₃) is very corrosive and may accelerate oxidation of machine parts. Further, relatively low concentrations of ozone in the atmosphere, for example from 1 ppm to 10 ppm, may cause headaches, nausea and irritation of mucous membranes. Heavier levels of ozone (O₃) are known to cause more severe respiratory problems.

The United States government has passed various regulations under the Occupational Safety and Health Administration (OSHA) limiting the emissions of ozone from industrial equipment, including electrophotographic copy machines. Thus, a need exists for an electrophotographic copy machine that can operate efficiently while limiting or reducing the production of ozone (O₃).

Controlling or eliminating the formation of the ozone (O₃) molecule is necessary, therefore, to minimize or eliminate the deterioration of the dicorotron shield and/or the photoreceptor surface because of acids during the electrophotographic printing of an image onto a receiving sheet, as well as to upgrade environmental conditions where such electrophotographic copy machines are operated.

### SUMMARY OF THE INVENTION

This invention provides an improved dicorotron shield comprising a single layer made of titanium or a titanium alloy, for example, whereby the titanium or titanium alloy reduces the formation of ozone (O₃) even when extreme high voltage energy is used to generate the energy necessary for charging the photoreceptor from the dicorotron shielded corona device. The reduction of ozone (O₃) changes the pattern of chemical reactions that normally occur in conventional two-layered shields having, for example, an aluminum outer structure with a coating of dispersed aqueous graphite (dispersed aqueous graphite) over-laying the aluminum on the interior side of the shield structure facing the photoreceptor to be charged.

The dicorotron shield of the present invention is comprised of a single layer of, for example, titanium or a titanium alloy. The single layer is formed by ordinary metal working tools to form the titanium or titanium alloy into the shield shape necessary or desired for placement and function in an imaging apparatus. No coating is placed on the titanium or titanium alloy shield thus formed. The single layer thus simplifies the manufacture of the dicorotron shield compared to the two-layered, for example, aluminum/graphite dicorotron shield discussed previously that requires dipping of the aluminum shield to place the dispersed aqueous graphite layer upon it. Further, the use of titanium or a titanium alloy reduces the continuing existence of ozone (O₃) notwithstanding the same high voltage agitation state that the corona device undergoes for transferring the charge to the charge-collecting photoreceptor. The unstable nature of the ozone (O₃) created by the high voltage state reacts differently in the presence of the single-layered titanium or titanium alloy shield of the invention compared to the reaction in, for example, the aluminum/graphite two-layered shield previously used. Whereas the ozone (O₃) would react with nitrogen (N₂) to form nitrous oxide (N₂O) in the presence of the aluminum/graphite shield, the ozone (O₃) instead collides with the titanium or titanium alloy shield of the present invention to surrender its extra oxygen atom to form di-atomic oxygen (O₂), for example, 2O₃=>3O₂ in the presence of the invention's titanium or titanium alloy shield. Thus, the nitrous oxide (N₂O) formed in the presence of the aluminum/graphite shield is less likely to be formed using the invention's titanium or titanium alloy dicorotron shield. Nitrous oxide (N₂O) is the necessary precursor to the problematic nitric acid (HNO₃) produced in previous electrophotgraphic machines. Because the nitrous oxide (N₂O) is less abundantly formed, if at all, the formation of nitric acid (HNO₃) is similarly avoided as well. As a result, the titanium or titanium alloy shield of the invention is not coated with the salt yielded from an acid-base reaction. Nitric acid damage to the photoreceptor is similarly avoided, providing significant operating savings. Further, cleaning of the invention's titanium or titanium alloy shield is more easily accomplished than in, for example, the aluminum/graphite shield previously used. The titanium or titanium alloy shield according to the invention may be cleaned simply with a wet cloth, whereas the water soluble dispersed aqueous graphite layer of the conventional two-layered shields could not be cleaned with water due to the water solubility of the graphite layer. Thus, replacement of the titanium or titanium alloy shield may never have to occur.

The durability of the titanium or titanium alloy shield according to the invention provides a further advantage over conventional two-layered, for example, aluminum/dispersed aqueous graphite, shields by providing hundreds of millions of copies or imaging cycles before, if ever, needing replacement, whereas the aluminum/dispersed aqueous graphite conventional shield requires replacement approximately every two million copies or imaging cycles. Thus, the titanium or titanium alloy shield according to the present invention poses a significant operating savings as well.

### BRIEF DESCRIPTION OF THE DRAWINGS

Various exemplary embodiments of this invention will be described in detail with reference to the following figures, wherein like numerals represent like elements, and wherein:

FIG. 1 is a schematic view of a electrophotographic apparatus;

FIG. 2 is a schematic cutaway view of a conventional electrophotographic apparatus having, for example, a photoreceptor and a corona charging device with a dicorotron shield made of, for example, an aluminum layer and a dispersed aqueous graphite (dispersed aqueous graphite) layer serving as a base reactant;

FIG. 3 is a cutaway view of a conventional dicorotron shield having, for example, an aluminum layer and a dispersed aqueous graphite (dispersed aqueous graphite) layer;

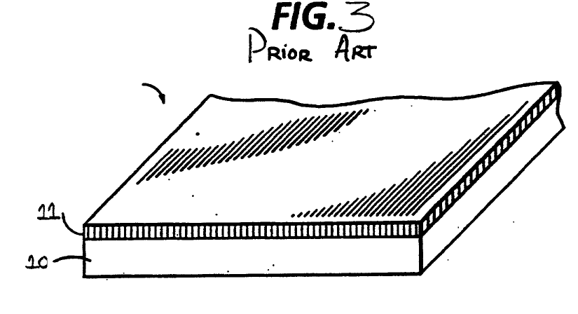

FIG. 4 is a schematic cutaway view of a photoreceptor and a corona charging device with a dicorotron shield made according to the present invention;

FIG. 5 is a cutaway view of a dicorotron shield according to the present invention; and

FIG. 6 is a schematic view of another embodiment of a dicorotron shield according to the present invention.

### DETAILED DESCRIPTION OF EXEMPLARY EMBODIMENTS

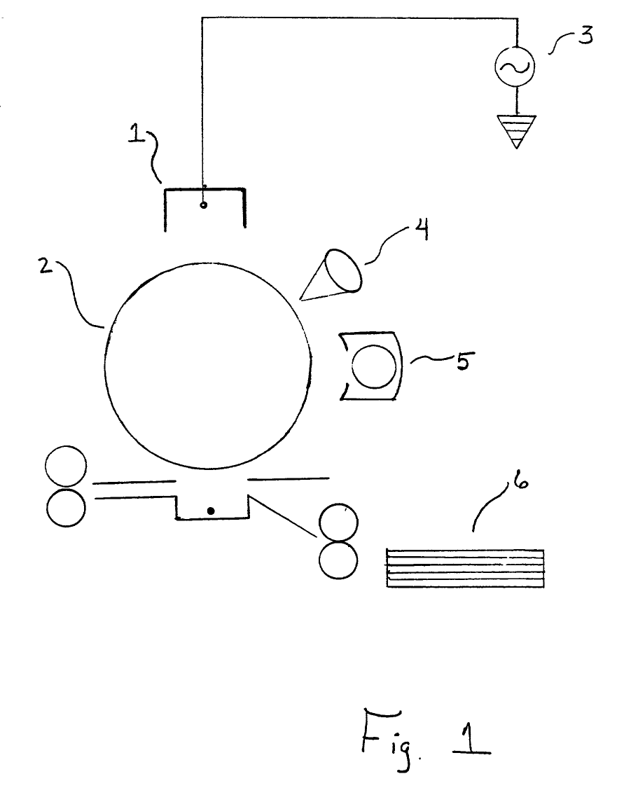

An electrophotographic printing apparatus is shown generally in FIG. 1. Electrophotographic printing using a corona device 1 as a charging means for charging a photoreceptor 2 is widely known and used. The corona device 1 receives very high voltages, up to for example 7000 volts, from an AC voltage source 3, to charge the charge-collecting photoreceptor 2. A conductive dicorotron shield comprises part of the corona device 1 and permits the charging of the corona device 1 to occur. The charge from the corona device 1 is transmitted to the charge-collecting photoreceptor 2. An electrostatic latent image is then formed on the photoreceptor 2 at the imaging station 4. For example, the electrostatic latent image can be formed by a laser beam in response to an electric signal, as is common in digital imaging printing applications, or by reflecting a light of an original document to be copied through an appropriate optical system, as is common in photographic imaging systems. After the appropriate locations of the photoreceptor have been discharged, an electrostatic latent image remains on the photoreceptor. The electrostatic latent image is comprised of the remaining charged locations on the photoreceptor. The photoreceptor's electrostatic latent image charged locations then receive oppositely charged toner particles from a toner dispenser 5 to produce a visible image. The visible image is re-produced onto a recording sheet 6 supplied to the printing cycle to complete the electrophotographic printing process.

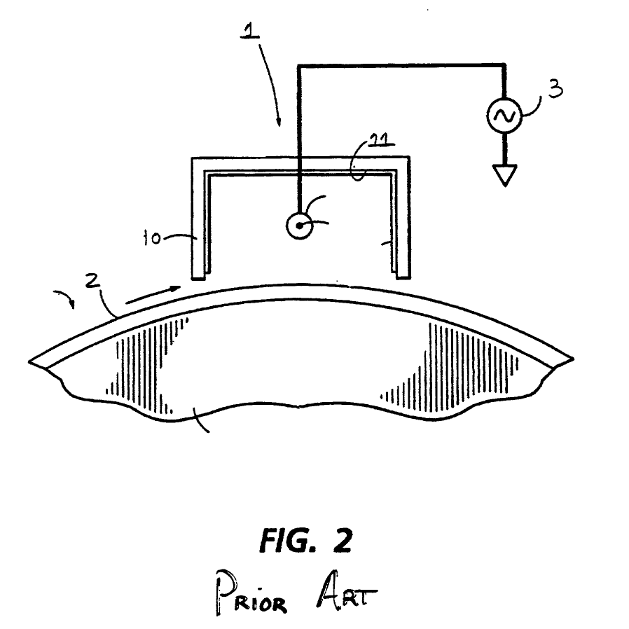

Corona charging devices 1 of known electrophotographic printing apparatus are often comprised of a conductive dicorotron shield having two layers 10 and 11, for example, as shown in FIG. 2. The two layers comprise for instance, an aluminum layer 10 forming the shell and shape of the shield overall, and a dispersed aqueous graphite layer 11 forming an intermediary layer. The intermediary dispersed aqueous graphite layer neutralizes ozone (O₃) production and inhibits formation of acids that otherwise form as a result of the ozone (O₃) produced due to the high voltage agitation surrounding the corona device 1 during electrophotographic printing. By controlling the ozone (O₃) production at the initial stages of electrophotographic printing, for example, the presence of subsequently formed acids, such as nitric acid (HNO₃) is diminished. The diminished presence of acids, for example nitric acid (HNO₃), minimizes the opportunity for acid-base reactions to occur in which a salt, such as ammonium nitrate (NH₄NO₃) can form. However, in conventional two-layered shields having a dispersed aqueous graphite layer 11, enough acids, for example nitric acid (HNO₃) are produced as a result of ozone (O₃) formed at the initial stage of the electrophotographic printing process to cause an acid-base reaction between the nitric acid (HNO₃) and the dispersed aqueous graphite layer 11. The acid-base reaction yields a salt that coats the dispersed aqueous graphite layer 11 and impairs its ozone (O₃) neutralizing and acid neutralizing effects. As a result, frequent cleaning or replacement of the conventional two-layered shield is required.

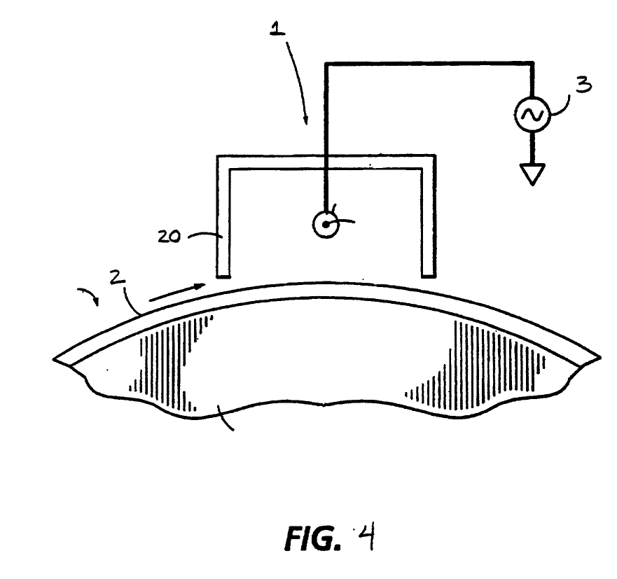

A single layer titanium or titanium alloy dicorotron shield 20 according to one exemplary embodiment of this invention is shown in FIG. 4. The dicorotron shield 20 comprises a single layer. The shield 20 is formable by simple metal working tools to simplify the manufacturing process and to minimize the manufacturing expense of the dicorotron shield 20. The thickness of the titanium or titanium alloy shield varies according to the size and shape of the imaging apparatus the shield will be placed in so that sufficient malleability of the titanium or titanium alloy is achieved to accomplish the shield shape necessary or desired to suit the designated imaging apparatus. The single layer of the dicorotron shield 20 is comprised of titanium or a titanium alloy. Titanium, even if in alloy form, is a known ozone (O₃) formation inhibiter. Thus, using titanium or a titanium alloy as the single layered dicorotron shield 20 according to this invention permits the reduction of ozone (O₃) formation to occur in an electrophotographic printing apparatus at even the earliest stages of the electrophotographic printing process. By reducing the formation of ozone (O₃), even when extreme high voltage energy is used to generate the energy necessary for charging the photoreceptor 2 from the corona device 1, the titanium or titanium alloy dicorotron shield controls the sequence of chemical reactions that occur in the presence of the single layered dicorotron shield 20 according to this invention as compared with the chemical reactions that occur in the presence of the conventional two-layered dicorotron shield shown in FIG. 2, for example.

More specifically, the single-layered titanium or titanium alloy dicorotron shield 20 according to this invention encourages the unstable ozone (O₃) molecules to contribute their extra oxygen (O) atoms within other extra oxygen (O) atoms released from the ozone (O₃) molecules by colliding with the titanium or titanium alloy shield 20. The formation of diatomic oxygen (O₂) from the unstable ozone (O₃) occurs generally as 2O₃=>3O₂, and is directly attributable to the ozone (O₃) inhibiting nature of the titanium or titanium alloy in the titanium or titanium alloy dicorotron shield 20 according to this invention. Because the oxygen (O₂) is more readily formed, rather than nitrous oxide (N₂O) as in the conventional two-layered shield having a dispersed aqueous graphite acid neutralizing layer, the formation of problematic acids, for example nitric acid (HNO₃) is less likely to be formed as well.

Thus, by reducing the formation of problematic acids, such as nitric acid (HNO₃), the likelihood of acid-base reactions yielding a shield coating salt is also reduced. As a result, the titanium or titanium alloy dicorotron shield, according to the present invention, remains free of any coating that would impair its ozone (O₃) limiting function. Further, the titanium or titanium alloy dicorotron shield according to the present invention limits the formation of problematic salt producing acids. Accordingly, the titanium or titanium alloy dicorotron shield lasts longer than conventional two-layered shields having an acid and salt producing dispersed aqueous graphite layer. Likewise, the titanium or titanium alloy dicorotron shield according to the invention requires less cleaning and maintenance than conventional two-layered shields that are subject to impairment as a result of the production of the problematic acids and salts they yield via reactions initiated by the ozone (O₃) originally formed at the onset of the electrophotographic printing process in an apparatus using the conventional two-layered shield having a dispersed aqueous graphite layer.

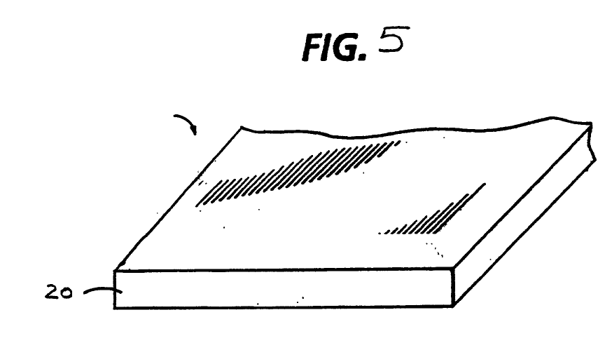

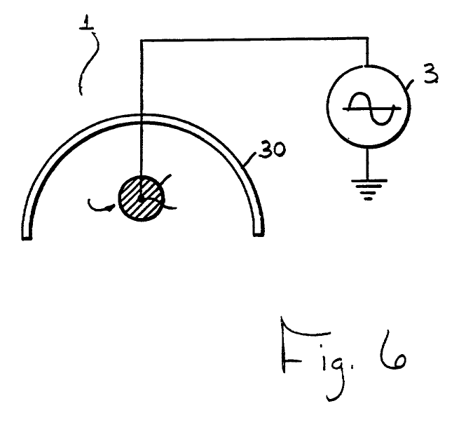

A second exemplary embodiment of the titanium or titanium alloy dicorotron shield according to the present invention is shown in FIG. 6, in which the single-layered shield 30 of the corona device 1 is provided in an arcuate shape as opposed to the box shape of the shield 20 depicted in FIGS. 4 and 5. Of course, as will be apparent to those skilled in the art, the particular shape of the dicorotron shield according to the present invention is not particularly limited. Any desired shape, including the shapes conventionally used in the art, can be utilized in the present invention. Further the surface texture of the shield according to the invention may be either smooth, rough or a combination thereof without defeating the ozone (O₃) and thus acid neutralizing effect of the shield.

According to the present invention, the dicorotron shield can be used in an electrostatographic or electrophotographic imaging apparatus for a period of time substantially longer than the dicorotron shields of the prior art. Thus, for example, the dicorotron shield of the present invention can substantially prevent production of nitric acid in the electrostatographic or electrophotographic imaging apparatus, and can thereby provide an effective service life of the shield of hundreds of millions of copies or imaging cycles before requiring replacement, and in fact may never require replacement. In various exemplary embodiments, the dicorotron shield of the present invention thus has an effective service life of at least about five million, preferably at least about 50 or 100 million, copies or imaging cycles. The titanium or titanium alloy shield according to the invention therefore outlasts the conventional two-layered aluminum/dispersed aqueous graphite shield, for example, which requires replacement after only one or two million copies or image cycles. Further, because the titanium or titanium alloy of the shield according to the present invention is not water soluble, as were conventional two-layered, for example, aluminum/dispersed aqueous graphite shields, the titanium or titanium shield is easier to maintain since it can be cleaned simply with a wet cloth. Still further, because of the durability of the titanium or titanium alloy shield according to the present invention, it can be substituted into a different imaging apparatus should the original imaging apparatus the titanium or titanium alloy shield was placed in ever wear out. The dexterity, durability and simplicity of the titanium or titanium alloy shield of the present invention therefore provides significant manufacturing, operational and maintenance costs over any of the conventional two-layered, for example, aluminum/dispersed aqueous graphite dicorotron shields used in imaging apparatuses thus far.

The present invention is also directed to imaging methods and imaging apparatuses useful in such methods. In particular, the present invention encompasses the use of the above-described dicorotron shield in an electrostatographic or electrophotographic imaging method and apparatus for developing images. Any suitable conventional electrostatographic or electrophotographic charging, exposure, development, transfer, fixing and cleaning techniques may be utilized to form and develop electrostatic latent images on an imaging member, provided that the conventional dicorotron shield of such apparatus is replaced by the dicorotron shield of the present invention. Thus, for example, conventional light lens or laser exposure systems may be used to form the electrostatic latent image. The resulting electrostatic latent image may be developed by suitable conventional development techniques such as magnetic brush, cascade, powder cloud, and the like. Suitable imaging methods that utilize toner particles are known in the art and are described, for example, in U.S. Pat. Nos. 4,585,884, 4,584,253, 4,563,408 and 4,265,990, the entire disclosures of which are incorporated herein by reference.

Of course, it should be appreciated that while the exemplary embodiments of the titanium or titanium alloy shield according to the present invention is shown in only two shapes as shown in FIGS. 4-6, the embodiments shown are exemplary only and are not intended to limit the shape of the shield according to the invention in any way. Many alternatives, including various shield shapes conducive to the ozone (O₃) limiting function provided by the titanium or titanium alloy dicorotron shield according to the invention, are within the skill of one reasonably skilled in the art. Such alternatives are understood to be within the spirit and scope of the invention.

What is claimed is:

1. An ozone neutralizing device for an electrophotographic printing apparatus having at least one of a corona charge generating device or a dicorotron charge generating device, the ozone neutralizing device comprising:
a replaceable cartridge forming a shield surrounding at least a portion of the at least one of the corona charge generating device or the dicorotron charge generating device, wherein the shield is made of one of titanium or a titanium alloy.

2. The ozone neutralizing device of claim 1, wherein the shield is multi-sided so as to surround at least a portion of the at least one of the corona charge generating device or the dicorotron charge generating device.

3. The ozone neutralizing device of claim 1, wherein the shield is arcuate so as to surround at least a portion of the at least one of the corona charge generating device or the dicorotron charge generating device.

4. The ozone neutralizing device of claim 1, wherein the shield is a collision surface causing ozone (O₃) to yield oxygen (O₂) which dictates the chemical reactions later in the electrophotographic printing process such that the shield remains substantially free of any coating impairing its ozone neutralizing effect.

5. A dicorotron unit, comprising:
a dicorotron charging apparatus; and
a shield, wherein the shield comprises at least one of titanium or a titanium alloy.

6. The dicorotron unit of claim 5, wherein the dicorotron charging apparatus comprises a charging wire.

7. The dicorotron unit of claim 5, wherein the shield is free of a graphite coating.

8. The dicorotron unit of claim 5, wherein the shield is a single-layer structure.

9. The dicorotron unit of claim 5, wherein the shield consists essentially of the titanium or the titanium alloy.

10. An electrostatographic imaging apparatus, comprising:
a photoreceptor;
a charging unit for charging the photoreceptor;
an exposure unit for forming a latent image on the photoreceptor;
a development unit for developing the latent image with electrostatic marking particles;
a transfer unit for transferring the electrostatic marking particles to a substrate; and
a fixing unit for fixing the transferred electrostatic marking particles onto the substrate.

11. The electrostatographic imaging apparatus of claim 10, wherein the shield is free of a graphite coating.

12. The electrostatographic imaging apparatus of claim 10, wherein the shield is a single-layer structure.

13. The electrostatographic imaging apparatus of claim 10, wherein the shield consists essentially of the titanium or the titanium alloy.

14. The electrostatographic imaging apparatus of claim 10, wherein the shield substantially prevents production of nitric acid in the electrostatographic imaging apparatus.

15. The electrostatographic imaging apparatus of claim 10, wherein the shield has an effective service life of greater than five million copies.
